(19) United States
(12) Patent Application Publication
(10) Pub. No.: US 2018/0173298 A1
(43) Pub. Date: Jun. 21, 2018

(54) AVERAGE CURRENT PROTECTION MECHANISM

(71) Applicant: Intel Corporation, Santa Clara, CA (US)

(72) Inventors: Alexander Gendler, Kiriat Motzkin (IL); Boris Mishori, Tsur Yitzhak (IL); Krishnakanth V. Sistla, Beaverton, OR (US); Ankush Varma, Hillsboro, OR (US); Avinash N. Ananthakrishnan, Portland, OR (US); Lev Makovsky, Haifa (IL); Michael Zelikson, Haifa (IL); Eran Altshuler, Kiriat Ata (IL); Israel Stolero, Moshav Zippori (IL)

(73) Assignee: Intel Corporation, Santa Clara, CA (US)

(21) Appl. No.: 15/381,611

(22) Filed: Dec. 16, 2016

(51) Int. Cl. G06F 1/32; G06F 1/20; G06F 1/04

(52) U.S. Cl. CPC G06F 1/3296; G06F 1/04; G06F 1/206; G06F 1/324

(57) ABSTRACT

An apparatus is provided, comprising: a first circuitry configured to generate a signal at a voltage level for one or more components; a second circuitry configured to generate a clock at a frequency level for the one or more components; a third circuitry configured to intermittently measure a current level of the signal; a fourth circuitry configured to estimate a first average of the current level of the signal over a first time-window; and a fifth circuitry configured to, in response to the first average being higher than a threshold average current, facilitate regulating one or both the voltage level of the signal or the frequency level of the clock.

### BACKGROUND

In modern days, electronic devices are getting smaller in size, which increases a current density in the circuits of these devices. Prolonged exposure to high current in a circuit can lead to over-heating, and can also lead to a deterioration of various circuit elements.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1A illustrates a system for controlling an average current generated by a voltage regulator (VR) circuitry, according to some embodiments.

FIG. 1B illustrates a system for controlling an average current generated by a voltage regulator circuitry, where one or more components of the system are included in an integrated circuit (IC) chip, according to some embodiments.

FIG. 2 illustrates a graph depicting a variation of an average value of a current over time, according to some embodiments.

FIG. 3A illustrates a method depicting a system entering a regulated mode of operation, according to some embodiments.

FIG. 3B illustrates a method depicting a system exiting the regulated mode of operation, according to some embodiments.

FIG. 4 illustrates a smart device or a computer system or a SoC (System-on-Chip) that selectively enters and exits the regulated mode of operation to control an average current, in accordance with some embodiments.

### DETAILED DESCRIPTION

In some embodiments, a computing system can have a voltage regulator circuitry that can regulate a voltage of an output signal. The voltage regulator circuitry can supply current to a plurality of components, e.g., via the output signal. The plurality of components can operate at a frequency level using a clock signal from a clock generator circuitry.

In some embodiments, it may be desired that an average value of the output current be lower than an average threshold current Ith for a time period T. For example, a current measurement circuitry can periodically sample the output signal and/or receive feedback from the voltage regulator circuitry, to measure the current of the output signal. An averaging circuitry can estimate an average value of the current of the output signal over different time windows. If, for example, the average value of the current of the output signal becomes higher than the average threshold current Ith over a first time-window, the voltage regulator circuitry and/or the clock generator circuitry can operate in a regulation mode, and respectively start throttling the voltage of the output signal and/or the frequency of the clock signal. In some embodiments, throttling the voltage and/or the frequency, for example, lowers the current consumed in the components to which the voltage regulator circuitry supplies current. Accordingly, the throttling gradually lowers the average current of the output signal. In some embodiments, the throttling continues until the average current of the output signal becomes lower than the average threshold current Ith.

There are many technical effects of the various embodiments. For example, selectively throttling the voltage of the output signal and/or the frequency of the clock signal ensures that the average current of the output signal is lower than the average threshold current Ith over the time period T. This assists in thermal management of the system, as well as reduces or prevents long term degradation of the circuit elements due to prolonged exposure to high currents.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.” The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C). The terms “left,” “right,” “front,” “back,” “top,” “bottom,” “over,” “under,” and the like in the description and in the claims, if any, are used for descriptive purposes and not necessarily for describing permanent relative positions.

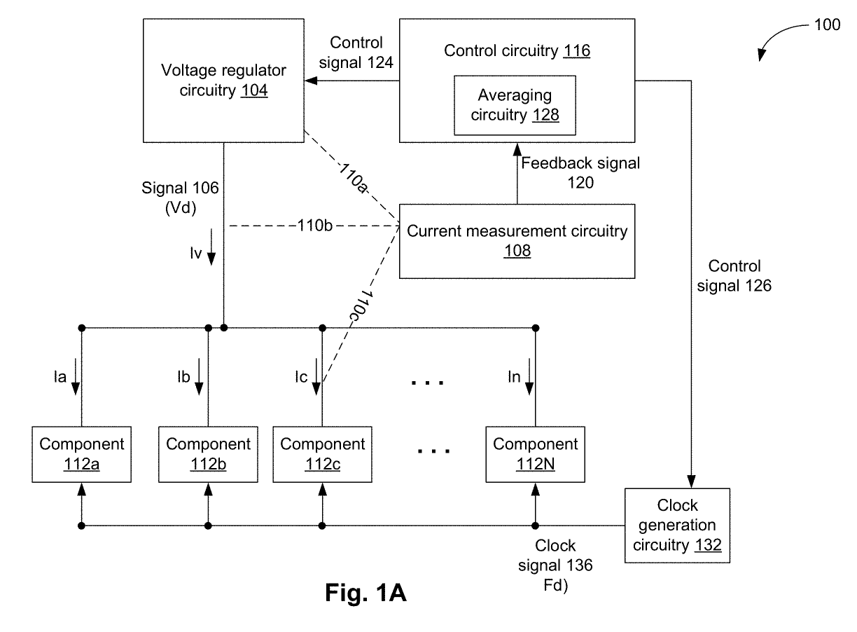

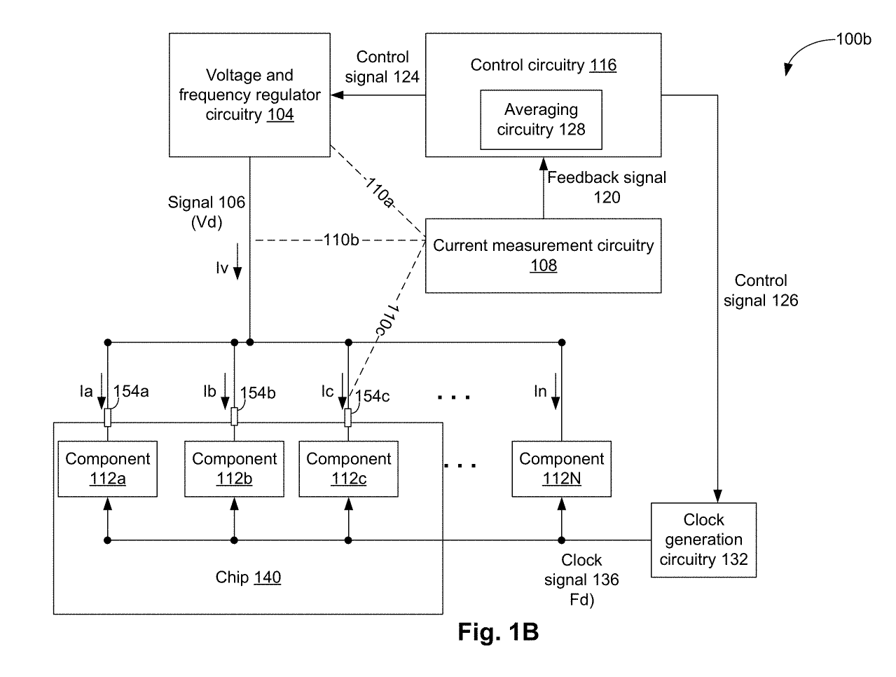

FIG. 1A illustrates a system 100 for controlling an average current generated by a voltage regulator circuitry 104 (henceforth also referred to as “circuitry 104”), according to some embodiments. In some embodiments, the circuitry 104 comprises appropriate components to regulate a voltage of a signal 106. In an example, the signal 106 has a voltage level Vd (henceforth referred to as a “voltage Vd”). In some embodiments, the circuitry 104 selectively regulates or controls the voltage Vd of the signal 104. In some embodiments, the circuitry 104 comprises a voltage regulator, e.g., a fully integrated voltage regulator (FIVR).

In some embodiments, the circuitry 104 supplies the signal 106 to a plurality of components 112a, 112b, 112c, . . . , 112N, where N is an appropriate positive integer. For example, the components 112a, . . . , 112N consume current Ia, . . . , In, respectively, which are supplied by the circuitry 104. For example, the circuitry 104 supplies current Iv to the components 112a, . . . , 112N, where Iv=Ia+ . . . +In. In an example, the circuitry 104 acts as a current source, supplying current to the components 112a, 112b, 112c, . . . , 112N.

In some embodiments, the components 112a, . . . , 112N receive a clock signal 136 (henceforth referred to as the “clock 136”) from a clock generation circuitry 132 (henceforth referred to as a “circuitry 132”). In an example, the clock 136 has a frequency Fd. Although FIG. 1A illustrates the components 112a, . . . , 112N receiving a clock 136 from a single circuitry 132, in another example, one or more of the components 112a, . . . , 112N can receive different clock signals, having different frequencies, from different clock generators.

The system 100, for example, can be implemented in any appropriate computing device, e.g., a laptop, a notebook, a smart phone, a cellular phone, a tablet, a desktop, a wearable device, an Internet-of-things (TOT), or the like. In some embodiments, the components 112a, . . . , 112N can be any appropriate components of the system 100. For example, individual ones of the components 112a, . . . , 112N can be a processor, a memory, one or more transistors, logic gates, logic units, a peripheral device, a circuitry, or any other appropriate type of component of the system 100.

In some embodiments, the system 100 comprises a current measurement circuitry 108 (henceforth also referred to as “circuitry 108”). The circuitry 108 is configured to measure the current Iv supplied by the circuitry 104. The circuitry 108 can measure the current Iv by one or more of a plurality of manners.

Merely as an example, the circuitry 108 can be integrated with (e.g., included within) the circuitry 104 (symbolically illustrated using the dotted line 110a in FIG. 1A), as a result of which the circuitry 108 can receive the value of the current Iv supplied by the circuitry 104. In another example, the circuitry 108 can monitor the signal line 106 (symbolically illustrated using the dotted line 110b in FIG. 1A), based on which the circuitry 108 can measure the current Iv.

In yet another example, the circuitry 108 can individually measure the currents Ia, Ib, Ic, . . . , In (symbolically illustrated using the dotted line 110c in FIG. 1A), based on which the circuitry 108 can estimate the current Iv. In yet another example, one or more of the currents Ia, Ib, . . . , In are correlated (e.g., have substantially similar values), and the circuitry 108 measures only one of the currents that are correlated to estimate the current Iv. For example, if each of the currents Ia, . . . , In have substantially similar values and the circuitry 108 measures the current Ia, then Iv can be estimated to be Iv*N, where N is the number of components 112a, . . . , 112N.

In some embodiments, the circuitry 108 is configured to generate a feedback signal 120 (henceforth also referred to as “signal 120”) and transmit the signal 120 to a control circuitry 116 (henceforth also referred to as “circuitry 116”). The circuitry 116 is configured to control an operation of the circuitry 104 and/or the circuitry 132. For example, the circuitry 116 generates and transmits a control signal 124 to the circuitry 104, based on which the circuitry 104 selectively regulates the voltage Vd of the signal 104. In another example, the circuitry 116 generates and transmits a control signal 126 to the circuitry 132, based on which the circuitry 132 regulates a frequency Fd of the clock 136. In some embodiments, the circuitry 116 comprises an averaging circuitry 128. Detailed operation of the circuitries 104, 108, 116, 128, and 132 are discussed herein later in further details.

In some embodiments, one or more of the components 112a, . . . , 112N are included in an integrated circuit chip. For example, FIG. 1B illustrates a system 100b for controlling an average current generated by the voltage regulator circuitry 104, where one or more of the components 112a, . . . , 112N are included in an integrated circuit chip 140 (henceforth also referred to as “chip 140”), according to some embodiments. Various components illustrated in FIG. 1B (e.g., circuitry 104, 108, 116, 128, 132, signals 106, 120, 124, 126, 136, etc.) are similar to their corresponding components in FIG. 1A, and hence, are labeled similarly in the two figures.

In some embodiments, the chip 140 comprises the components 112a, 112b, and 112c, while the component 112N is external to the chip 140 (although, for example, in some other embodiments, all the components 112a, . . . , 112N can be included in the chip 140). In some embodiments, the components 112a, 112b, and 112c receive the currents Ia, Ib, and Ic, respectively, via appropriate chip interconnect structures 154a, 154b, and 154c, respectively. The chip interconnect structures 154a, 154b, and 154c, for example, are pins of the chip 140.

Although the components 104, 108, 116, 128, and 132 are illustrated to be located external to the chip 140, in some embodiments, one or more of these components can be included within the chip 140. Although the chip 140 has many other components, these components are not illustrated in FIG. 1B for purposes of illustrative clarity.

In some embodiments, the circuitry 108 measures the current Iv, as discussed herein with respect to FIG. 1A. The current measurement is transmitted to the circuitry 116, for example, as the signal 120. In some embodiments, the circuitry 128 computes an average of the current Iv over a time-window. In some embodiments, in response to the average value of the current Iv over the time-window exceeding a threshold value, the circuitry 116 regulates the circuitry 104 and/or the circuitry 132, e.g., by controlling a voltage Vd of the signal 106 and/or a frequency Fd of the clock 136.

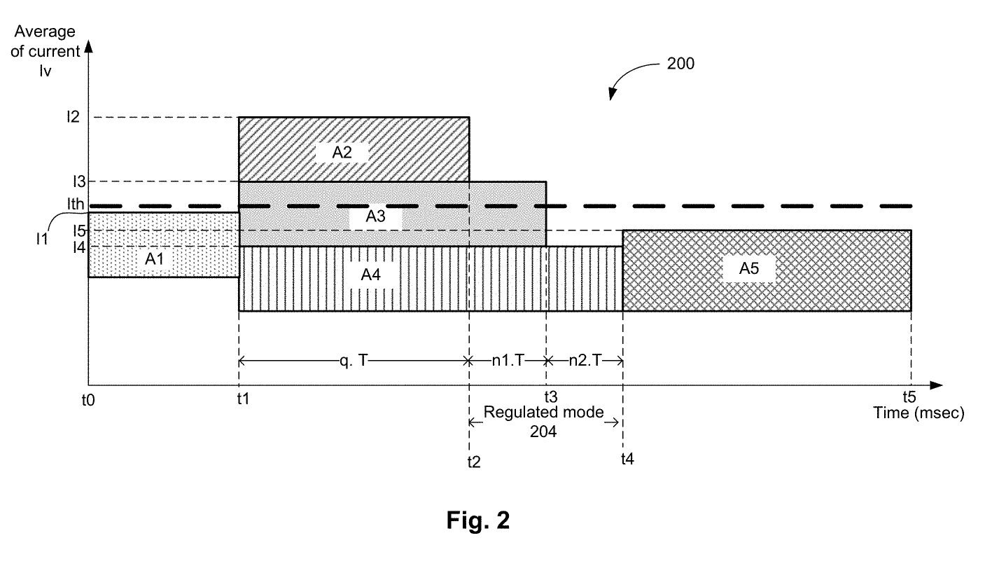

FIG. 2 illustrates a graph 200 depicting a variation of an average value of the current Iv of the signal 106 over time, according to some embodiments. The x axis of the graph 200 denotes the time, and the y axis of the graph 200 denotes the average of the current Iv. The time along the x axis is measured using any unit for time (e.g., milliseconds, or ms), and the average of the current Iv is measured using any unit for current (e.g., amperes).

In some embodiments, the averaging of the current Iv is performed by the circuitry 128. For example, the circuitry 128 receives samples of measurements of the current Iv from the circuitry 108, based on which the circuitry 128 measures the average of the current Iv over various time-windows.

FIG. 2 illustrates various areas (e.g., A1, A2, . . . , A5) in the graph 200 that are filled using respective patterns. A height of an area (e.g., the dimension of the area along the y axis) does not signify anything. A length of an area (e.g., the dimension of the area along the x axis) signify a respective time-window associated with the area. Furthermore, a y axis value at a top line of an area signify an average current Iv associated with the area. For the purposes of this disclosure and unless otherwise mentioned, a time-window ta−tb refers to a time period between time tb and time ta (e.g., assuming that time tb occurs subsequent to time ta).

For example, the area A1 represents an average value I1 of the current Iv over a time-window spanning from time t0 to time t1 (e.g., a time-window t0−t1), the area A2 represents an average value I2 of the current Iv over a time-window t1−t2, the area A3 represents an average value I3 of the current Iv over a time-window t1−t3, the area A4 represents an average value I4 of the current Iv over a time-window t1−t4, and the area A5 represents an average value I5 of the current Iv over a time-window t4−t5. The graph 200 also illustrates (e.g., using a bold dotted line) a threshold average current Ith.

Although each of the areas A1, . . . , A5 have a top line that is horizontal in FIG. 2, e.g., implying that the average current remains constant over a time-window associated with the corresponding area, the average current can vary with time. FIG. 2 is merely for illustrative purposes, and each of the areas A1, . . . , A5 depict an approximate value of the corresponding average current. Merely as an example, an area represents an average of the average current for the corresponding time-window. For example, for the time-window spanning between time t0 and t1 (e.g., for the area A1), the average current I1 is an average of the average current over the time-window t0−t1.

Referring to FIGS. 1A, 1B and 2, assume that the circuitry 108 starts measuring the current at time t0. From time t0 to t1, the average current I1 is slightly less than the threshold current Ith, and hence, the circuitry 116 does not regulate the circuitry 104 and/or the circuitry 132.

Assume that at time t1 (or at time that starts some time before t1), the current Iv increases. For example, the system can start operating at a turbo mode or a boost mode (e.g., at an increased voltage and/or frequency), depending on a computational workload of the system 100. As a result, the average current I2 of the area A2 raises above the threshold average current Ith.

In some embodiments, once the circuitry 116 detects that the average current from time t1 is above the threshold average current Ith for at least a threshold period of time (e.g., from time t1 to t2), the circuitry 116 starts regulating the circuitry 104 and/or the circuitry 132. For example, the system operates in a regulated mode 204 starting from time t2, as illustrated in FIG. 2.

While operating in the regulated mode 204, the circuitry 116 regulates the frequency Fd of the clock 136 and/or the voltage Vd of the signal 106, e.g., by regulating the circuitry 132 and/or the circuitry 104 via the control signals 124 and 126, respectively. For example, while operating in the regulated mode 204, the circuitry 116 decreases the frequency Fd of the clock 136 and/or the voltage Vd of the signal 106.

In some embodiments, a decrease in the frequency Fd and/or the voltage Vd results in a corresponding decrease in the current Iv. For example, when a component (e.g., the component 112a) starts operating at a decreased frequency and/or at a decreased voltage, the component consumes less current Ia, thereby contributing to a decrease in the current Iv of the signal 106.

In some embodiments, one or more of the components 112a, . . . , 112N can react relatively quickly to a decrease in the frequency Fd than a decrease in the voltage Vd. For example, assuming that in a first case the frequency Fd is decreased by a certain percentage and in a second case the voltage Vd is decreased by another certain percentage—a decrease in the current Iv in the first case can be more rapid and higher than the decrease in the current Iv in the second case. Accordingly, merely as an example, while the system 100 operates in the regulated mode 204, the circuitry 116 regulates the circuitry 132 such that the frequency Fd of the clock 132 is decreased. However, in another example, in addition to, or instead of, decreasing the frequency Fd, the voltage Vd of the signal 106 can also be decreased.

As discussed, a decrease in the frequency Fd and/or the voltage Vd can result in a decrease in the current Iv of the signal 106. For example, from time t2, the current Iv starts decreases. As a result, the average of the current Iv starts decreasing from time t2. However, in an example, the average current I3 is still higher than the threshold average current Ith, as a result of which the system 100 continues to operate in the regulated mode 204 at time t3 and after.

From time t3, the average current drops below the threshold average current Ith. For example, for the area A4 that starts at time t4, the average current I4 is less than the threshold current Ith. Accordingly, once the average current I4 stabilizes and is still below the threshold average current Ith for at least some period of time (e.g., from time t3 to t4), at time t4 the circuitry 116 ceases from regulating the circuitry 132 and/or the circuitry 104. For example, the regulated mode 204 of the system 100 terminates at time t4. Accordingly, from time t4, the frequency Fd and/or the voltage Vd starts increasing, thereby resulting in, for example, an increase in the current Iv. However, in the area A5 (e.g, in the time-window t4−t5), the average current I5 is still less than the threshold average current Ith. Accordingly, the system 100 does not further enter the regulated mode 204.

In some embodiments, a time period T is defined for the system 100. The time period T, for example, is 100 milliseconds (ms), 200 ms, or the like. The system 100 enters the regulated mode 204, for example, if the average of the current Iv is higher than the threshold average current Ith for at least a threshold period of time, where the threshold period of time, for example, is q*T. For example, the time-window in FIG. 2 between time t1 and t2 is illustrated as q*T.

In an example, the value of q is a user configurable parameter, and q can be a fraction. Merely as an example, q is ½. Thus, for T=200 ms, the system 100 enters the regulated mode 204 if the average of the current Iv is higher than threshold average current Ith for at least 100 ms. Such a parameter is defined, for example, so that the system 100 can still operate at a higher current Iv, a higher frequency Fd and/or a higher voltage Vd for short duration, e.g., during a turbo or boost mode of operation. However, the regulated mode 104 ensures that such a duration is short enough, e.g., by ensuring the average of the current Iv is not too high for a prolonged period of time.

It is to be noted that in some embodiments and as illustrated in FIG. 2, the area A3 is associated with the time-window t1−t3, whereas the area A2 is associated with the time-window t1−t2. For instance, the time-window t1−t3 of the area A3 encompasses the time-window t1−t2 of the area A2, and has an additional incremental time-window between times t2 and t3. Similarly, the time-window t1−t4 of the area A4 encompasses the time-window t1−t2, and two additional incremental time-windows t2−t3 and t3−t4. Thus, for example, if the current Iv has very high values between time t1 and t2, the current Iv has to have lower values subsequently, e.g., to ensure that the average current over a long period of time (e.g., at least over the time period T) in less than the threshold average current Ith.

In some embodiments, after entering the regulated mode 204, the circuitry 116 check for the most current value of the average current Iv and decides whether to continue in the regulated mode 204 periodically. For example, the circuitry 116 checks for the most current value of the average current Iv and decides whether to continue in the regulated mode 204 every n1*T ms, where n1 is a fraction (although, the circuitry 108 can measure the current Iv more frequently). Merely as an example, n1=⅛. Accordingly, for the example where T is 200 ms and n1=⅛, the circuitry 116 checks for the most current value of the average current Iv and decides whether to continue in the regulated mode every 25 ms. Thus, in FIG. 2, merely as an example, the time between t2 and t3 is n1*T, e.g., 25 ms.

Although FIG. 2 illustrates the average of the current Iv dropping below the threshold average current Ith within 25 ms of the system 100 operating in the regulated mode 204, in another example, the system operates in 50 ms, 75 ms, or the like in the regulated mode 204, before the average of the current Iv drops below the threshold average current Ith.

Also, in FIG. 2, the time period between time t3 and t4 is n2*T. In an example, n2=⅛. Thus, after about 25 ms of operating under the average threshold current Ith, the system 100 exits the regulated mode 204.

In some embodiments, as the regulation of the frequency Fd and/or the voltage Vd is associated with throttling of the frequency Fd and/or the voltage Vd, the regulated mode 204 is also referred to as a throttling mode, and regulation of the circuitries 132 and/or 104 is also referred to as throttling these circuitries.

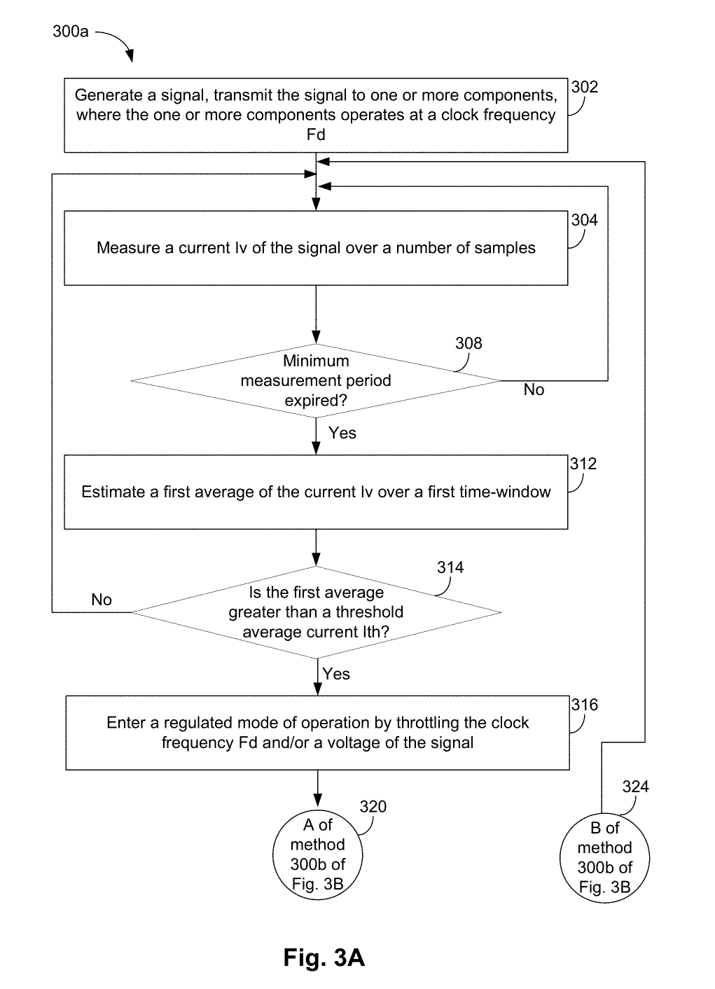

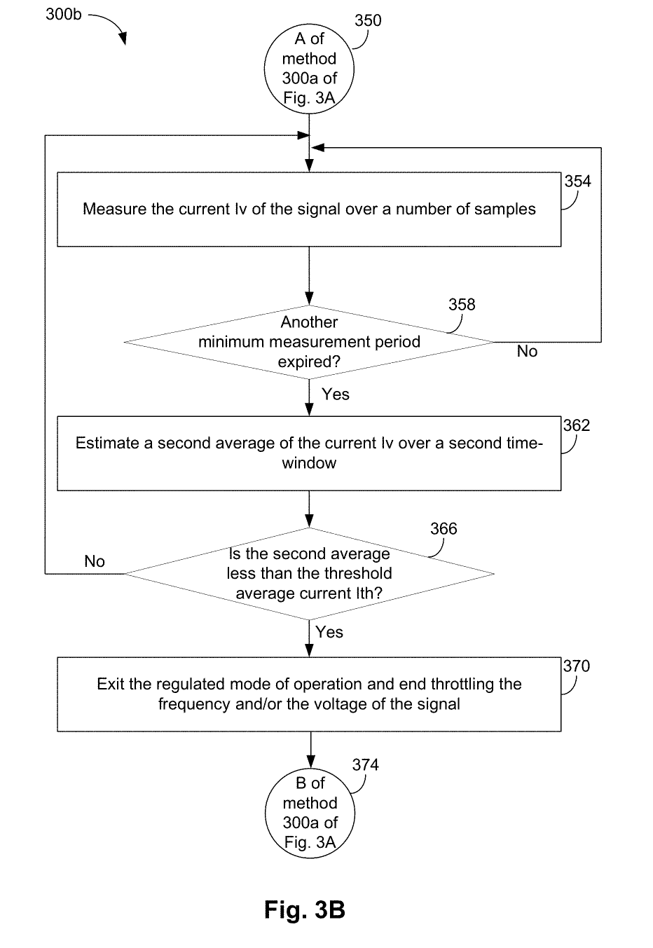

FIG. 3A illustrates a method 300a depicting a system (e.g., the system 100 of FIGS. 1A-1B) entering a regulated mode of operation (e.g., the regulated mods 204 of FIG. 2), according to some embodiments.

At 302, a signal (e.g., the signal 106) is generated, e.g., by the circuitry 104. In some embodiments, the signal is transmitted to one or more components, e.g., components 112a, . . . , 112N. In some embodiments, the one or more components operates at the clock frequency Fd, e.g., receives the clock 136 having the frequency Fd.

At 304, a current Iv of the signal is measured, e.g., by the circuitry 108. In some embodiments, the circuitry 108 continuously, periodically and/or intermittently measures the current Iv over a plurality of samples.

In some embodiments, the current is measured for at least a minimum period of time. For example, if a time period is T and n1 is a fraction, as discussed herein above, the measurement samples are taken over at least a time-window n1*T, before an estimate of the average of the current Iv is made. Accordingly, at 308, a determination is made as to whether a minimum measurement period has expired, where the minimum measurement period is, for example, n1*T. If the minimum measurement period is not over yet (e.g., if “No” at 308), the method 300a loops back to 304, e.g., where further measurements of the current Iv is performed.

If the minimum measurement period is over (e.g., if “Yes” at 308), the method 300a proceeds to 312, where a first average of the current Iv over a first time-window is estimated (e.g., by the circuitry 128). Merely as an example, the first average is I2 of FIG. 2, and the first time-window is between time t1 and time t2 (e.g., time-window t1−t2). As a further example, the first time-window has a duration of q*T, as discussed with respect to FIG. 2. Although the first average of the current Iv over the first time-window is estimated, any other appropriate function of the current Iv can also be estimated (e.g., a maximum value of the current Iv over the first time-window, a time-weighted average of the current over the first time-window, etc.).

At 314, the first average is compared to the threshold average current Ith. If the first average is less than or equal to the threshold average current Ith (e.g., if “No” at 314), the method 300a loops back to 304, where further measurements of the current Iv is taken, and the first average over a new first time-window is generated.

In some embodiments, the first average at 312 is estimated by taking several current samples over the first window, adding the current samples, and dividing the sum by the number of samples taken. In some embodiments where the first average is estimated after the method 300a loops back from 314 (e.g., if older time-window with older current samples existed), then the first average is taken by discarding at least some of the older current samples, and replacing the older current samples with newer current samples. Thus, in an example, when the method 300a continues looping between the blocks 304, 308, 312, and 314, the first time-window can a moving time window, whereas and when new samples become available, older samples in the first average are replaced with the newer samples to update the estimation of the first average.

If at 314 the first average is greater than the threshold average current Ith (e.g., if “Yes” at 314), the method 300a proceeds to 316. At 316, the system enters the regulated mode of operation 204. For example, the frequency Fd of the clock 136 and/or the voltage of the signal 104 is regulated (e.g., throttled or reduced), e.g., by the circuitry 104 and/or the circuitry 132 based on receiving the signals 124 and/or 126, respectively, from the circuitry 116. From 316, the method proceeds to a block 320, which represents a block A of a method 300b of FIG. 3B.

In some embodiments, the amount by which the frequency Fd and/or the voltage Vd are throttled can be based on, for example, the comparison of the first average and the threshold average current Ith. For example, the amount by which the frequency Fd and/or the voltage Vd are throttled can be relatively higher for a relatively higher difference between the first average and the threshold average current Ith. Also, the amount by which the frequency Fd and/or the voltage Vd are throttled can be relatively lower for a relatively lower difference between the first average and the threshold average current Ith. Thus, if the average current if very high relative to the threshold average current Ith, then the frequency Fd and/or the voltage Vd are drastically reduced, e.g., to bring the average current below the threshold average current Ith quickly. On the other hand, if the average current if slightly high relative to the threshold average current Ith, then the frequency Fd and/or the voltage Vd can be slightly reduced, because such a slight reduction can be sufficient to bring the average current below the threshold average current Ith.

In some embodiments, the threshold average current Ith can be a user configurable parameter. In an example, the threshold average current Ith can be dynamically adjusted based on, for example, thermal management, computational workload of the system 100, etc. For example, if a temperature of one or more components of the system 100 is already relatively high, the threshold average current Ith can be set to a relatively lower value (e.g., to avoid further heating of the system by means of a higher average current). In an example, in such a situation, the first time-window can also be reduced, e.g., to allow momentarily high current to last for a shorter duration. On the other hand, if the temperature of one or more components of the system 100 is relatively low, the threshold average current Ith can be set to a relatively higher value and/or the first time-window can be lengthened.

FIG. 3B illustrates a method 300b depicting a system (e.g., the system 100 of FIGS. 1A-1B and 3A) exiting the regulated mode of operation, according to some embodiments. The method 300b is a continuation of the method 300b of FIG. 3A. For example, the method 300b starts at 350, which is continuation of 320 of FIG. 3A. At 354, further measurements of the current Iv is performed (e.g., similar to the measurement at 304 of the method 300a). At 358, it is determined whether another minimum measurement period has expired. The other minimum measurement period of 358, can be, for example, n1*T, as discussed with respect to FIG. 2, and n1, for example, is ⅛. If “No” at 358, the method 300b loops back at 354, where further samples of the current Iv is measured.

If “Yes” at 358, the method proceeds to 362, where a second average of the current Iv over a second time-window is estimated. At 366, the second average is compared to the threshold average current Ith, e.g., a determination is made as to whether the second average current is less than the threshold current Ith. If “No” at 366, the method 300b loops back to 354, where further current samples are measured, and an updated second average current for an updated second time window is estimated.

If “Yes” at 366 (e.g., if the second average current is less than the threshold), then at 370, the system 100 exits the regulation mode of operation 204, and ends throttling the frequency Fd and/or the voltage Vd. Subsequently, the method 300b proceeds to 374, from where it loops back to block 304 of the method 300a of FIG. 3A.

In some embodiments, the second time-window of the block 362 encompasses the first time-window of the block 312 of the method 300a and some additional time. Merely as an example, the second time-window is the time window between time t1 and t3 (e.g., corresponding to the area A3), and/or the time window between time t1 and t4 (e.g., corresponding to the area A4), as discussed with respect to FIG. 2. For example, referring to FIGS. 2 and 3A-3B, the method 300b is executed from time t2, e.g., when the system 100 enters the regulated mode 204. The first iteration of the block 366 of method 300b can be, for example, executed at or right before time t3, where the second average would be the average current I3, and the second time-window can be, for example, between times t1 and t3. As the current I3 is still higher than the average current Ith, the method 300b can loop back to 354 for a second iteration. During the second iteration, an updated second average current is estimated for an updated second-time window, which respectively corresponds to the average current I4 and the time-window t1−t4. Furthermore, the other minimum measurement period of the block 358 can, for example, correspond to the difference between times t2 and t3, or between times t3 and t4.

In some embodiments, the second average of the current Iv can be determined by a variety of ways. For example, assume, with reference to FIG. 2, that the second average time-window of the block 362 is the time-window t1−t4. In an example, the average current for the time-window t1−t4 can be calculated based on the average currents for the time-window t1−t2, the time-window t2−t3 and the time window t3−t4. For example, by the time the second iteration of the block 312 is executed, the average currents for the time-windows t1−t2 and t2−t3 have been previously estimated. For example, the average current for the time window t1−t2 has been estimated in the block 312 of the method 300a, and let this be I2. Also, the average current for the time window t2−t3 has been estimated in the first iteration of the block 362 of the method 300b, and let this be It23. During the second iteration of the block 362, for example, let the average current in the time-window t34 be estimated as It34. Then the second average current for the time window t14 can be estimated as:

((number of samples in the time-window t1−t2*I2)+(number of samples in the time-window t2−t3*It23)+(number of samples in the time-window t2−t3*It34))/(summation of the number of samples in the time-windows t1−t2, t2−t3 and t3−t4). Equation 1.

Several variations of equation 1 can also be used. Merely as example, all the current samples of the time-window t1−t4 can be added, and then divided by the number of samples in the time-window t1−t4.

In yet another example, the second average current for the time window t14 can be estimated as:

((number of samples in the time-window t1−t2*I2)+(number of samples in the time-window t2−t4*It24))/(summation of the number of samples in the time-windows t1−t2 and t2−t4), Equation 2.

where It24 is the average current in the time-window t2−t4.

There are many technical effects of the various embodiments. For example, selectively throttling the voltage Vd of the signal 106 and/or the frequency Fd of the clock 136 ensures that the average current of the signal 106 is lower than the average threshold current Ith over the time period T. This helps in thermal management of the system, as well as reduces or prevents long term degradation of various circuit elements of the system 100 due to prolonged exposure to high currents.

Although the blocks in the flowchart with reference to FIGS. 3A-B are shown in a particular order, the order of the actions can be modified. Thus, the illustrated embodiments can be performed in a different order, and some actions/blocks may be performed in parallel. Some of the blocks and/or operations listed in FIGS. 3A-B are optional in accordance with certain embodiments. The numbering of the blocks presented is for the sake of clarity and is not intended to prescribe an order of operations in which the various blocks must occur.

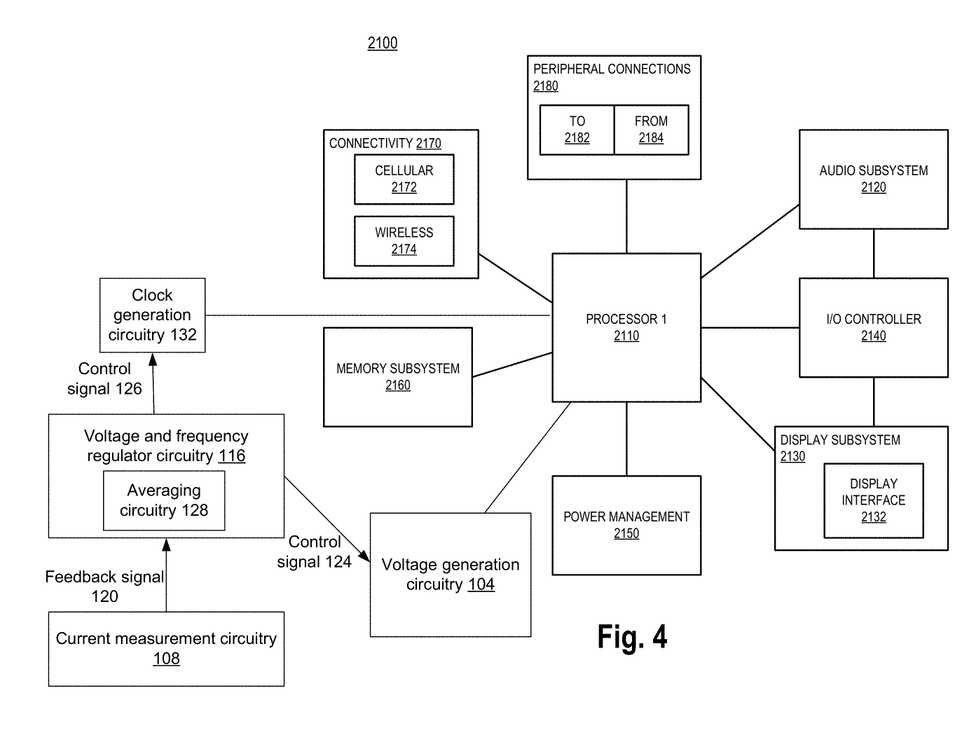

FIG. 4 illustrates a smart device or a computer system or a SoC (System-on-Chip) 2100 that selectively enters and exits the regulated mode of operation 204 to control an average current (e.g., supplied by the circuitry 104), in accordance with some embodiments. It is pointed out that those elements of FIG. 4 having the same reference numbers (or names) as the elements of any other figure can operate or function in any manner similar to that described, but are not limited to such.

In some embodiments, computing device 2100 represents an appropriate computing device, such as a computing tablet, a mobile phone or smart-phone, a laptop, a desktop, an Internet-of-things (IOT) device, a server, a set-top box, a wireless-enabled e-reader, or the like. It will be understood that certain components are shown generally, and not all components of such a device are shown in computing device 2100.

In some embodiments, computing device 2100 includes a first processor 2110. The various embodiments of the present disclosure may also comprise a network interface within 2170 such as a wireless interface so that a system embodiment may be incorporated into a wireless device, for example, cell phone or personal digital assistant.

In one embodiment, processor 2110 can include one or more physical devices, such as microprocessors, application processors, microcontrollers, programmable logic devices, or other processing means. The processing operations performed by processor 2110 include the execution of an operating platform or operating system on which applications and/or device functions are executed. The processing operations include operations related to I/O (input/output) with a human user or with other devices, operations related to power management, and/or operations related to connecting the computing device 2100 to another device. The processing operations may also include operations related to audio I/O and/or display I/O.

In one embodiment, computing device 2100 includes audio subsystem 2120, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 2100, or connected to the computing device 2100. In one embodiment, a user interacts with the computing device 2100 by providing audio commands that are received and processed by processor 2110.

Display subsystem 2130 represents hardware (e.g., display devices) and software (e.g., drivers) components that provide a visual and/or tactile display for a user to interact with the computing device 2100. Display subsystem 2130 includes display interface 2132, which includes the particular screen or hardware device used to provide a display to a user. In one embodiment, display interface 2132 includes logic separate from processor 2110 to perform at least some processing related to the display. In one embodiment, display subsystem 2130 includes a touch screen (or touch pad) device that provides both output and input to a user.

I/O controller 2140 represents hardware devices and software components related to interaction with a user. I/O controller 2140 is operable to manage hardware that is part of audio subsystem 2120 and/or display subsystem 2130. Additionally, I/O controller 2140 illustrates a connection point for additional devices that connect to computing device 2100 through which a user might interact with the system. For example, devices that can be attached to the computing device 2100 might include microphone devices, speaker or stereo systems, video systems or other display devices, keyboard or keypad devices, or other I/O devices for use with specific applications such as card readers or other devices.

As mentioned above, I/O controller 2140 can interact with audio subsystem 2120 and/or display subsystem 2130. For example, input through a microphone or other audio device can provide input or commands for one or more applications or functions of the computing device 2100. Additionally, audio output can be provided instead of, or in addition to display output. In another example, if display subsystem 2130 includes a touch screen, the display device also acts as an input device, which can be at least partially managed by I/O controller 2140. There can also be additional buttons or switches on the computing device 2100 to provide I/O functions managed by I/O controller 2140.

In one embodiment, I/O controller 2140 manages devices such as accelerometers, cameras, light sensors or other environmental sensors, or other hardware that can be included in the computing device 2100. The input can be part of direct user interaction, as well as providing environmental input to the system to influence its operations (such as filtering for noise, adjusting displays for brightness detection, applying a flash for a camera, or other features).

In one embodiment, computing device 2100 includes power management 2150 that manages battery power usage, charging of the battery, and features related to power saving operation. Memory subsystem 2160 includes memory devices for storing information in computing device 2100. Memory can include nonvolatile (state does not change if power to the memory device is interrupted) and/or volatile (state is indeterminate if power to the memory device is interrupted) memory devices. Memory subsystem 2160 can store application data, user data, music, photos, documents, or other data, as well as system data (whether long-term or temporary) related to the execution of the applications and functions of the computing device 2100.

Elements of embodiments are also provided as a machine-readable medium (e.g., memory 2160) for storing the computer-executable instructions (e.g., instructions to implement any other processes discussed herein). The machine-readable medium (e.g., memory 2160) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity 2170 includes hardware devices (e.g., wireless and/or wired connectors and communication hardware) and software components (e.g., drivers, protocol stacks) to enable the computing device 2100 to communicate with external devices. The computing device 2100 could be separate devices, such as other computing devices, wireless access points or base stations, as well as peripherals such as headsets, printers, or other devices.

Connectivity 2170 can include multiple different types of connectivity. To generalize, the computing device 2100 is illustrated with cellular connectivity 2172 and wireless connectivity 2174. Cellular connectivity 2172 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 2174 refers to wireless connectivity that is not cellular, and can include personal area networks (such as Bluetooth, Near Field, etc.), local area networks (such as Wi-Fi), and/or wide area networks (such as WiMax), or other wireless communication.

Peripheral connections 2180 include hardware interfaces and connectors, as well as software components (e.g., drivers, protocol stacks) to make peripheral connections. It will be understood that the computing device 2100 could both be a peripheral device (“to” 2182) to other computing devices, as well as have peripheral devices (“from” 2184) connected to it. The computing device 2100 commonly has a “docking” connector to connect to other computing devices for purposes such as managing (e.g., downloading and/or uploading, changing, synchronizing) content on computing device 2100. Additionally, a docking connector can allow computing device 2100 to connect to certain peripherals that allow the computing device 2100 to control content output, for example, to audiovisual or other systems.

In addition to a proprietary docking connector or other proprietary connection hardware, the computing device 2100 can make peripheral connections 2180 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, the computing device 2100 comprises the circuitries 104, 108, 116, 128, and 132 of FIGS. 1A-1B. The circuitry 104, for example, transmits current to the processor 2110 and/or one or more other components of the computing device 2100. The circuitry 132, for example, supplies a clock signal to the processor 2100 and/or one or more other components of the computing device 2100. The circuitry 108 and 116, for example, facilitates selective entry and exit of the circuitries 132 and/or 104 from the regulated mode 204.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following example clauses pertain to further embodiments. Specifics in the example clauses may be used anywhere in one or more embodiments. All optional features of the apparatus described herein may also be implemented with respect to a method or process.

Clause 1. An apparatus comprising: a first circuitry to generate a signal at a voltage level for one or more components; a second circuitry to generate a clock at a frequency level for the one or more components; a third circuitry to intermittently measure a current level of the signal; a fourth circuitry to estimate a first average of the current level of the signal over a first time-window; and a fifth circuitry to, in response to the first average being higher than a threshold average current, facilitate regulating one or both the voltage level of the signal or the frequency level of the clock.

Clause 2. The apparatus of clause 1, wherein: the fourth circuitry is to further estimate a second average of the current level of the signal over a second time-window; the second time-window encompasses (i) the first time-window and (ii) a third time-window that immediately follows the first time-window; and the fifth circuitry is to further, in response to the second average being less than or equal to the threshold average current, facilitate an end of regulation of one or both the voltage level or the frequency level.

Clause 3. The apparatus of clause 2, wherein the fourth circuitry is to estimate the second average of the current level of the signal over the second time-window by: estimating a third average of the current level over the third time-window; and based at least in part on the first average and the third average, estimating the second average of the current level of the signal over the second time-window.

Clause 4. The apparatus of clause 1, wherein: the fourth circuitry is further to estimate a second average of the current level of the signal over a second time-window, the second time-window encompassing (i) the first time-window and (ii) a first incremental time-window that immediately follows the first time-window; and the fifth circuitry is further to, in response to the second average being higher than the threshold average current, continue facilitating regulation of one or both the voltage level or the frequency level.

Clause 5. The apparatus of clause 4, wherein: the third circuitry is further to estimate a third average of the current level of the signal over a third time-window, the third time-window encompassing (i) the first time-window, (ii) the first incremental time-window that immediately follows the first time-window, and (iii) a second incremental time-window that immediately follows the first incremental time-window; and the fourth circuitry is further to, in response to the third average being less than or equal to the threshold average current, facilitate an end of regulation of one or both the voltage level or the frequency level.

Clause 6. The apparatus of any of clauses 1-5, wherein: prior to a commencement of the first time-window, the frequency level of the clock has a first value; and in response to the first average being higher than the threshold average current, one or both the voltage level or the frequency level is regulated such that the frequency level of the clock is decreased to a second value that is lower than the first value.

Clause 7. The apparatus of any of clauses 1-5, wherein: a difference between the first value of the frequency level and the second value of the frequency level is based at least in part on a difference between the first average and the threshold average current.

Clause 8. The apparatus of any of clauses 1-7, wherein: prior to a commencement of the first time-window, the voltage level of the signal has a first value; in response to the first average being higher than the threshold average current, one or both the voltage level or the frequency level is regulated such that the voltage level of the signal is decreased to a second value that is lower than the first value; and a difference between the first value of the voltage level and the second value of the voltage level is based at least in part on a difference between the first average and the threshold average current.

Clause 9. The apparatus of any of clauses 1-8, further comprising: the one or more components that are to consume current generated by the first circuitry.

Clause 10. The apparatus of any of clauses 1-9, wherein the threshold average current is a configurable parameter that is based at least in part on one or more of a thermal management of the apparatus or a computational workload of the apparatus.

Clause 11. The apparatus of any of clauses 1-10, wherein the threshold average current is a configurable parameter that is based at least in part on a temperature of a component of the apparatus.

Clause 12. An apparatus comprising: a plurality of components to (i) receive current from a current source and (ii) receive a clock signal from a clock signal generator; current measurement circuitry to measure current generated by the current source; and a control circuitry to, in response to a function of the measured current being higher than a threshold level, regulate one or both the current source or the clock signal generator.

Clause 13. The apparatus of clause 12, wherein the function of the measured current comprises a first average of the current over a first time-window.

Clause 14. The apparatus of clause 13, wherein the control circuitry is further to: in response to a second average of the current over a second time-window being less than or equal to the threshold level, end the regulation of one or both the current source or the clock signal generator.

Clause 15. The apparatus of any of clauses 12-14, wherein the control circuitry is further to: regulate one or both the current source or the clock signal generator by throttling a frequency of the clock signal generated by the clock signal generator.

Clause 16. A system comprising: a memory; a processor coupled to the memory; a clock generation circuitry to generate a clock for the processor; a first circuitry to generate a signal at a voltage level for the processor; a second circuitry to intermittently measure a current level of the signal; a third circuitry to estimate a first average of the current level of the signal over a first time-window; and a fourth circuitry to, in response to the first average being higher than a threshold average current, facilitate regulating one or both the voltage level or the frequency level.

Clause 17. The system of clause 16, wherein: the third circuitry is further to estimate a second average of the current level of the signal over a second time-window; the second time-window encompasses (i) the first time-window and (ii) a third time-window that immediately follows the first time-window; and the fourth circuitry is further to, in response to the second average being less than or equal to the threshold average current, facilitate an end of regulation of one or both the voltage level or the frequency level.

Clause 18. The system of any of clauses 16-17, wherein: prior to a commencement of the first time-window, the frequency level of the signal has a first value; and in response to the first average being higher than the threshold average current, one or both the voltage level or the frequency level is regulated such that the frequency level of the signal is decreased to a second value that is lower than the first value, wherein a difference between the first value of the frequency level and the second value of the frequency level is based at least in part on a difference between the first average and the threshold average current.

Clause 19. The system of any of clauses 16-18, wherein: prior to a commencement of the first time-window, the voltage level of the signal has a first value; in response to the first average being higher than the threshold average current, one or both the voltage level or the frequency level is regulated such that the voltage level of the signal is decreased to a second value that is lower than the first value; and a difference between the first value of the voltage level and the second value of the voltage level is based at least in part on a difference between the first average and the threshold average current.

Clause 20. The system of any of clauses 16-19, wherein the threshold average current is a configurable parameter that is based at least in part on one or more of a thermal management of the apparatus or a computational workload of the apparatus.

Clause 21. A computer implemented method comprising: supplying current to a plurality of components via a signal that has a voltage level; operating the plurality of components at a frequency level; measuring a current level of the signal; estimating a first average of the current level of the signal over a first time-window; and in response to the first average being higher than a threshold average current, regulating one or both the voltage level or the frequency level.

Clause 22. The method of clause 21, further comprising: estimating a second average of the current level of the signal over a second time-window, wherein the second time-window encompasses (i) the first time-window and (ii) a third time-window that immediately follows the first time-window; and in response to the second average being less than or equal to the threshold average current, ending the regulation of one or both the voltage level or the frequency level.

Clause 23. The method of any of clauses 21-22, wherein regulating one or both the voltage level or the frequency level of the signal comprises: regulating the frequency level of the signal such that the frequency level is decreased from a first value to a second value.

Clause 24. The method of clause 23, wherein: a difference between the first value of the frequency level and the second value of the frequency level is based at least in part on a difference between the first average and the threshold average current.

Clause 25. The method of any of clauses 21-24, wherein regulating one or both the voltage level or the frequency level of the signal comprises: regulating the voltage level of the signal such that the voltage level is decreased from a first value to a second value.

Clause 26. An apparatus comprising: means for performing the method in any of the clauses 21-24.

Clause 27. An apparatus comprising: means for supplying current to a plurality of components via a signal that has a voltage level; means for operating the plurality of components at a frequency level; means for measuring a current level of the signal; means for estimating a first average of the current level of the signal over a first time-window; and means for in response to the first average being higher than a threshold average current, regulating one or both the voltage level or the frequency level.

Clause 28. The apparatus of clause 27, further comprising: means for estimating a second average of the current level of the signal over a second time-window, wherein the second time-window encompasses (i) the first time-window and (ii) a third time-window that immediately follows the first time-window; and means for ending, in response to the second average being less than or equal to the threshold average current, the regulation of one or both the voltage level or the frequency level.

Clause 29. The apparatus of any of clauses 27-28, wherein the means for regulating one or both the voltage level or the frequency level of the signal comprises: means for regulating the frequency level of the signal such that the frequency level is decreased from a first value to a second value.

Clause 30. The apparatus of clause 29, wherein: a difference between the first value of the frequency level and the second value of the frequency level is based at least in part on a difference between the first average and the threshold average current.

Clause 31. The apparatus of any of clauses 27-30, wherein the means for regulating one or both the voltage level or the frequency level of the signal comprises: means for regulating the voltage level of the signal such that the voltage level is decreased from a first value to a second value.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. An apparatus comprising:
a first circuitry to generate a signal at a voltage level for one or more components;
a second circuitry to generate a clock at a frequency level for the one or more components;
a third circuitry to intermittently measure a current level of the signal;
a fourth circuitry to estimate a first average of the current level of the signal over a first time-window; and
a fifth circuitry to, in response to the first average being higher than a threshold average current, facilitate regulating one or both the voltage level of the signal or the frequency level of the clock.

2. The apparatus of claim 1, wherein:
the fourth circuitry is to further estimate a second average of the current level of the signal over a second time-window;
the second time-window encompasses (i) the first time-window and (ii) a third time-window that immediately follows the first time-window; and
the fifth circuitry is to further, in response to the second average being less than or equal to the threshold average current, facilitate an end of regulation of one or both the voltage level or the frequency level.

3. The apparatus of claim 2, wherein the fourth circuitry is to estimate the second average of the current level of the signal over the second time-window by:
estimating a third average of the current level over the third time-window; and
based at least in part on the first average and the third average, estimating the second average of the current level of the signal over the second time-window.

4. The apparatus of claim 1, wherein:
the fourth circuitry is further to estimate a second average of the current level of the signal over a second time-window, the second time-window encompassing (i) the first time-window and (ii) a first incremental time-window that immediately follows the first time-window; and
the fifth circuitry is further to, in response to the second average being higher than the threshold average current, continue facilitating regulation of one or both the voltage level or the frequency level.

5. The apparatus of claim 4, wherein:
the third circuitry is further to estimate a third average of the current level of the signal over a third time-window, the third time-window encompassing (i) the first time-window, (ii) the first incremental time-window that immediately follows the first time-window, and (iii) a second incremental time-window that immediately follows the first incremental time-window; and
the fourth circuitry is further to, in response to the third average being less than or equal to the threshold average current, facilitate an end of regulation of one or both the voltage level or the frequency level.

6. The apparatus of claim 1, wherein:
prior to a commencement of the first time-window, the frequency level of the clock has a first value; and
in response to the first average being higher than the threshold average current, one or both the voltage level or the frequency level is regulated such that the frequency level of the clock is decreased to a second value that is lower than the first value.

7. The apparatus of claim 1, wherein:
a difference between the first value of the frequency level and the second value of the frequency level is based at least in part on a difference between the first average and the threshold average current.

8. The apparatus of claim 1, wherein:
prior to a commencement of the first time-window, the voltage level of the signal has a first value;
in response to the first average being higher than the threshold average current, one or both the voltage level or the frequency level is regulated such that the voltage level of the signal is decreased to a second value that is lower than the first value; and
a difference between the first value of the voltage level and the second value of the voltage level is based at least in part on a difference between the first average and the threshold average current.

9. The apparatus of claim 1, further comprising:
the one or more components that are to consume current generated by the first circuitry.

10. The apparatus of claim 1, wherein the threshold average current is a configurable parameter that is based at least in part on one or more of a thermal management of the apparatus or a computational workload of the apparatus.

11. The apparatus of claim 1, wherein the threshold average current is a configurable parameter that is based at least in part on a temperature of a component of the apparatus.

12. An apparatus comprising:
a plurality of components to (i) receive current from a current source and (ii) receive a clock signal from a clock signal generator;
current measurement circuitry to measure current generated by the current source; and
a control circuitry to, in response to a function of the measured current being higher than a threshold level, regulate one or both the current source or the clock signal generator.

13. The apparatus of claim 12, wherein the function of the measured current comprises a first average of the current over a first time-window.

14. The apparatus of claim 13, wherein the control circuitry is further to:
in response to a second average of the current over a second time-window being less than or equal to the threshold level, end the regulation of one or both the current source or the clock signal generator.

15. The apparatus of claim 12, wherein the control circuitry is further to:
regulate one or both the current source or the clock signal generator by throttling a frequency of the clock signal generated by the clock signal generator.

16. A system comprising:
a memory;
a processor coupled to the memory;
a clock generation circuitry to generate a clock for the processor;
a first circuitry to generate a signal at a voltage level for the processor;
a second circuitry to intermittently measure a current level of the signal;
a third circuitry to estimate a first average of the current level of the signal over a first time-window; and
a fourth circuitry to, in response to the first average being higher than a threshold average current, facilitate regulating one or both the voltage level or the frequency level.

17. The system of claim 16, wherein:
the third circuitry is further to estimate a second average of the current level of the signal over a second time-window;
the second time-window encompasses (i) the first time-window and (ii) a third time-window that immediately follows the first time-window; and
the fourth circuitry is further to, in response to the second average being less than or equal to the threshold average current, facilitate an end of regulation of one or both the voltage level or the frequency level.

18. The system of claim 16, wherein:
prior to a commencement of the first time-window, the frequency level of the signal has a first value; and
in response to the first average being higher than the threshold average current, one or both the voltage level or the frequency level is regulated such that the frequency level of the signal is decreased to a second value that is lower than the first value,
wherein a difference between the first value of the frequency level and the second value of the frequency level is based at least in part on a difference between the first average and the threshold average current.

19. The system of claim 16, wherein:
prior to a commencement of the first time-window, the voltage level of the signal has a first value;
in response to the first average being higher than the threshold average current, one or both the voltage level or the frequency level is regulated such that the voltage level of the signal is decreased to a second value that is lower than the first value; and
a difference between the first value of the voltage level and the second value of the voltage level is based at least in part on a difference between the first average and the threshold average current.

20. The system of claim 16, wherein the threshold average current is a configurable parameter that is based at least in part on one or more of a thermal management of the apparatus or a computational workload of the apparatus.
